(19) United States
(12) Patent Application Publication
(10) Pub. No.: US 2026/0153681 A1
(43) Pub. Date: Jun. 4, 2026

(54) MICRO-RING RESONATOR AND METHOD OF MANUFACTURING THE SAME

(71) Applicant: SAMSUNG ELECTRONICS CO., LTD., Suwon-si (KR)

(72) Inventors: Byunggil JEONG, Suwon-si (KR); Seogwoo HONG, Suwon-si (KR); Minkyung LEE, Suwon-si (KR)

(73) Assignee: SAMSUNG ELECTRONICS CO., LTD., Suwon-si (KR)

(21) Appl. No.: 19/195,227

(22) Filed: Apr. 30, 2025

(30) Foreign Application Priority Data
Nov. 29, 2024 (KR) 10-2024-0175806

(51) Int. Cl. G02B 6/293; G02B 6/122; G02B 6/136

(52) U.S. Cl. CPC G02B 6/29338; G02B 6/122; G02B 6/136

(57) ABSTRACT

A micro-ring resonator and a method of manufacturing the same are provided. The micro-ring resonator includes a substrate, an insulating layer provided on the substrate, a linear waveguide provided on the insulating layer, a first electrode provided on the linear waveguide, a ring waveguide provided on the insulating layer and coupled with the linear waveguide, and a second electrode provided on the ring waveguide. The insulating layer includes a cavity formed below a portion of the linear waveguide, the portion being adjacent to the ring waveguide.

### CROSS-REFERENCE TO RELATED APPLICATION

This application is based on and claims priority under 35 U.S.C. § 119 to Korean Patent Application No. 10-2024-0175806, filed on Nov. 29, 2024, in the Korean Intellectual Property Office, the disclosure of which is incorporated by reference herein in its entirety.

### BACKGROUND

### 1. Field

The disclosure relates to a micro-ring resonator and a method of manufacturing the same.

### 2. Description of Related Art

A photonic integrated circuit (PIC) includes a laser diode that generates light, passive elements that split the generated light into various paths, and recombine the light split into the various paths, and a grating coupler that radiates the light into the atmosphere. Micro-ring resonators are optical components that have found many applications, including but not limited to, modulators, optical switching and filtering, laser generation, and optical routing.

### SUMMARY

Provided is a micro-ring resonator and a method of manufacturing the same.

Additional aspects will be set forth in part in the description which follows and, in part, will be apparent from the description, or may be learned by practice of the presented embodiments of the disclosure.

According to an aspect of the disclosure, there is provided a micro-ring resonator including: a substrate, an insulating layer on the substrate, a linear waveguide on the insulating layer, a first electrode on the linear waveguide, a ring waveguide on the insulating layer and coupled with the linear waveguide; and a second electrode on the ring waveguide, wherein the insulating layer may include a cavity below a portion of the linear waveguide, the portion of the linear waveguide being adjacent to the ring waveguide.

The portion of the linear waveguide may be configured to vertically deform toward the substrate based on a voltage applied between the first electrode and the substrate.

The portion of the linear waveguide may be configured to horizontally deform toward the ring waveguide based on a voltage applied between the first electrode and the second electrode.

The cavity may extend below a portion of the ring waveguide.

The substrate may include silicon.

Each of the linear waveguide and the ring waveguide may include a micro-ring resonator including silicon.

The first electrode may be provided on at least one of an upper surface and a side surface of the linear waveguide, and the second electrode may be on at least one of an upper surface and a side surface of the ring waveguide.

Each of the first electrode and the second electrode may include a conductive metal.

The micro-ring resonator may include a modulator provided adjacent to the ring waveguide.

The modulator may include a thermo-optic modulator or an electro-optic modulator.

According to another aspect of the disclosure, there is provided a method of manufacturing a micro-ring resonator, the method including: preparing a silicon on insulator (SOI) wafer including a silicon substrate, an insulating layer, and a silicon layer that are sequentially stacked; forming an etch hole in the silicon layer; forming a cavity by etching the insulating layer through the etch hole; forming a linear waveguide and a ring waveguide by patterning the silicon layer; and forming a first electrode on the linear waveguide and a second electrode on the ring waveguide.

The forming the linear waveguide may include forming a portion of the linear waveguide above the cavity, the portion of the linear waveguide being adjacent to the ring waveguide.

The cavity may be formed to extend below a portion of the ring waveguide.

The first electrode may be formed on at least one of an upper surface of the linear waveguide and a side surface of the linear waveguide, and the second electrode may be formed on at least one of an upper surface of the ring waveguide and a side surface of the ring waveguide.

According to another aspect of the disclosure, there is provided a method of manufacturing a micro-ring resonator, the method including: preparing a first silicon substrate; forming a first insulating layer on an upper surface of the first silicon substrate; forming a cavity by patterning the first insulating layer; preparing a silicon on insulator (SOI) wafer including a second silicon substrate, a second insulating layer, and a silicon layer that are sequentially stacked; bonding the silicon layer of the SOI wafer to the first insulating layer; removing the second silicon substrate and the second insulating layer of the SOI wafer; forming a linear waveguide and a ring waveguide by patterning the silicon layer; and forming a first electrode on the linear waveguide and a second electrode on the ring waveguide.

The forming the linear waveguide may include forming a portion of the linear waveguide above the cavity, the portion of the linear waveguide being adjacent to the ring waveguide.

The cavity may be formed to extend below a portion of the ring waveguide.

The first electrode may be formed on at least one of an upper surface of the linear waveguide and a side surface of the linear waveguide, and the second electrode may be formed on at least one of an upper surface of the ring waveguide and a side surface of the ring waveguide.

The silicon layer of the SOI wafer is bonded to the first insulating layer by silicon direct bonding (SDB).

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a perspective view illustrating a related art micro-ring resonator;

FIG. 2A is a plan view illustrating region C of FIG. 1;

FIG. 2B is a cross-sectional view taken along line I-I′ of FIG. 2A;

FIG. 3A illustrates a resonance wavelength according to a gap between a linear waveguide and a ring waveguide in the micro-ring resonator illustrated in FIG. 1;

FIG. 3B illustrates a resonance wavelength according to an effective thickness of the waveguide in the micro-ring resonator illustrated in FIG. 1;

FIG. 4A illustrates a change in a full width at half maximum (FWHM) and resonance wavelength according to a change in a gap between the linear waveguide and the ring waveguide in the micro-ring resonator illustrated in FIG. 1;

FIG. 4B illustrates a change in the FWHM and resonance wavelength according to a change in an effective thickness H of the waveguide in the micro-ring resonator illustrated in FIG. 1;

FIG. 5 is a perspective view illustrating a micro-ring resonator according to an embodiment;

FIG. 6 is a plan view of the micro-ring resonator illustrated in FIG. 5;

FIG. 7A is a cross-sectional view taken along line A-A′ of FIG. 6;

FIG. 7B is a cross-sectional view taken along line B-B′ of FIG. 6;

FIG. 8 is a cross-sectional view illustrating a modified example of a micro-ring resonator according to an embodiment;

FIGS. 9A and 9B are cross-sectional views illustrating a state in which no voltage is applied between a first electrode and a substrate in the micro-ring resonator according to the embodiment illustrated in FIG. 5;

FIGS. 10A and 10B are cross-sectional views illustrating a state in which a voltage is applied between the first electrode and the substrate in the micro-ring resonator according to the embodiment illustrated in FIG. 5;

FIG. 11A is a cross-sectional view illustrating a state in which no voltage is applied between the first electrode and a second electrode in the micro-ring resonator according to the embodiment illustrated in FIG. 5;

FIG. 11B is a cross-sectional view illustrating a state in which a voltage is applied between the first electrode and the second electrode in the micro-ring resonator according to the embodiment illustrated in FIG. 5;

FIG. 12 is a plan view illustrating a micro-ring resonator according to another embodiment;

FIGS. 13A to 13E are diagrams for describing a method of manufacturing a micro-ring resonator, according to an embodiment; and

FIGS. 14A to 14G are diagrams for describing a method of manufacturing a micro-ring resonator, according to another embodiment.

### DETAILED DESCRIPTION

Reference will now be made in detail to embodiments, examples of which are illustrated in the accompanying diagrams, wherein like reference numerals refer to like elements throughout. In this regard, the embodiments of the disclosure may have different forms and should not be construed as being limited to the descriptions set forth herein. Accordingly, the embodiments are merely described below, by referring to the figures, to explain aspects. As used herein, the term “and/or” includes any and all combinations of one or more of the associated listed items. Expressions such as “at least one of,” when preceding a list of elements, modify the entire list of elements and do not modify the individual elements of the list. For example, the expression, “at least one of a, b, and c,” should be understood as including only a, only b, only c, both a and b, both a and c, both b and c, or all of a, b, and c.

Hereinafter, embodiments will be described in detail with reference to the attached drawings. In the following drawings, the same reference numerals refer to the same components, and the size of each component in the drawings may be exaggerated for clarity and convenience of description. Also, the embodiments described herein may have different forms and should not be construed as being limited to the descriptions set forth herein.

Hereinafter, it will also be understood that when an element is referred to as being “on” or “above” another element, the element may be directly above, below, left, or right of the other element and in direct contact with another element or other intervening elements may be present. The singular forms include the plural forms unless the context clearly indicates otherwise. It should be understood that, when a part “comprises” or “includes” an element in the specification, unless otherwise defined, other elements are not excluded from the part and the part may further include other elements.

The use of the terms “a”, “an” and “the” and similar referents are to be construed to cover both the singular and the plural. The operations or steps of all methods described herein may be performed in any suitable order unless otherwise indicated herein or otherwise clearly contradicted by context.

Also, in the specification, the term “... units” or “...modules” denote units or modules that process at least one function or operation, and may be realized by hardware, software, or a combination of hardware and software. The hardware may include, but is not limited to, a memory, a processor or a circuit. The software may include a program code or an instruction. The software may be stored in the memory and the processor may execute the software to perform one or more operations.

The connecting lines, or connectors illustrated in the various figures presented are intended to represent exemplary functional relationships and/or physical or logical couplings between the various elements. It should be noted that many alternative or additional functional relationships, physical connections or logical connections may be present in a practical device.

The use of any and all examples, or exemplary language provided herein, is intended merely to better illuminate the disclosure and does not pose a limitation on the scope of the disclosure unless otherwise claimed.

Electronic devices for optical switching in photonic integrated circuits (PICs) may include, but is not limited to, Mach-Zehnder interferometers (MZIs) and micro-ring resonators. Micro-ring resonators may perform optical switching by shifting the wavelength characteristics by controlling the refractive index of an optical waveguide using thermo-optic or electro-optic mechanisms. Micro-ring resonators have the advantages of being compact and having high Q-values, but they have the disadvantage that their optical characteristics are greatly affected by deviations caused by fabrication process variations (FPVs) that occur during the manufacturing process.

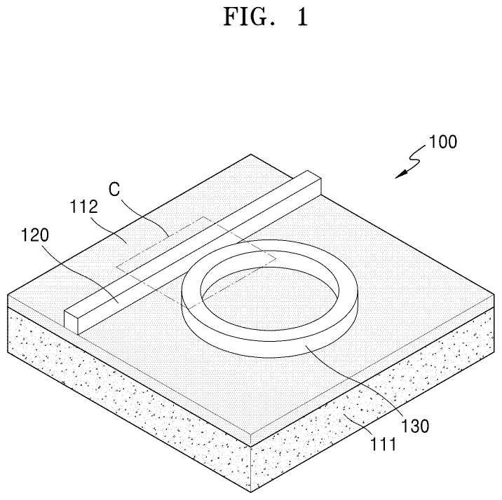

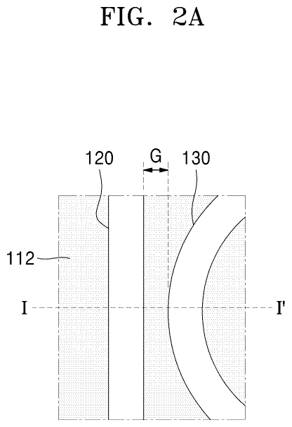

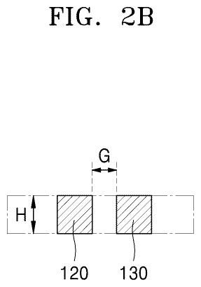

FIG. 1 is a perspective view illustrating a related art micro-ring resonator 100. FIG. 2A is a plan view illustrating region C of FIG. 1, and FIG. 2B is a cross-sectional view taken along line I-I′ of FIG. 2A.

Referring to FIGS. 1, 2A and 2B, the micro-ring resonator 100 includes a substrate 111 and an insulating layer 112 formed on the substrate 111. The substrate 111 may include, for example, silicon. However, the disclosure is not limited thereto. The insulating layer 112 may include silicon oxide. For example, the insulating layer 112 may be formed by oxidizing a surface of the substrate 111 including silicon, but is not limited thereto. For example, the insulating layer 112 may include various materials other than silicon oxide.

The micro-ring resonator 100 may further include a linear waveguide 120 and a ring waveguide 130 provided on the insulating layer 112. In The linear waveguide 120 may be referred to as a straight waveguide. The linear waveguide 120 and the ring waveguide 130 are spaced apart from each other by a certain gap G and are arranged to be coupled with each other. Here, the gap G between the linear waveguide 120 and the ring waveguide 130 refers to a gap at positions where the linear waveguide 120 and the ring waveguide 130 are closest to each other. An effective thickness H of a waveguide is a thickness of a space where coupling is formed between a linear waveguide and a ring waveguide. For example, the effective thickness H of the waveguide refers to a thickness of a space corresponding to t portion of the linear waveguide 120 and a portion of the ring waveguide 130 that face each other. FIG. 1 illustrates a case where the linear waveguide 120 and the ring waveguide 130 are provided with a same thickness on a same plane. Thus, the effective thickness H of the waveguide may be equal to a thickness H of each of the linear waveguide 120 and the ring waveguide 130. The linear waveguide 120 and the ring waveguide 130 may each include, for example, silicon. However, embodiments of the disclosure are not limited thereto. According to an embodiment, an insulating material may be provided to cover each of the linear waveguide 120 and the ring waveguide 130.

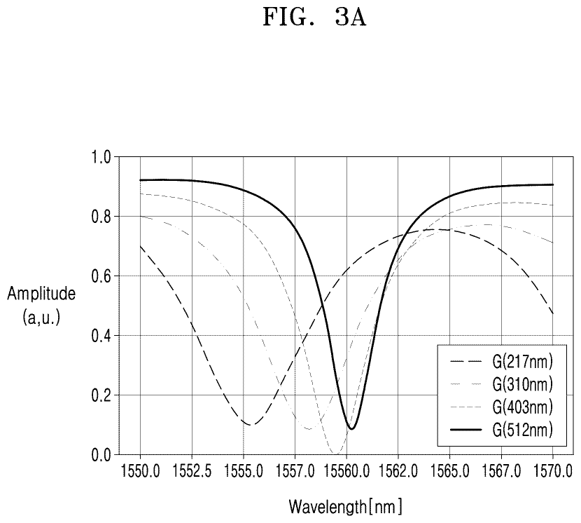

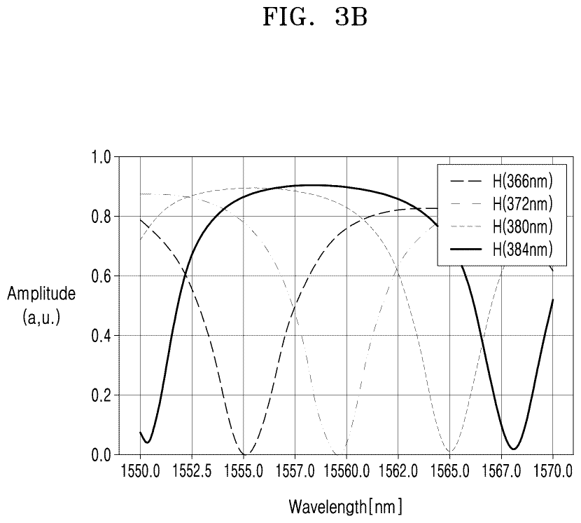

FIG. 3A is a simulation result showing a change in resonance wavelength according to the gap G between the linear waveguide 120 and the ring waveguide 130 in the micro-ring resonator 100 illustrated in FIG. 1. FIG. 3A shows measured resonance wavelengths when the gap G between the linear waveguide 120 and the ring waveguide 130 is 217 nm, 310 nm, 403 nm, or 512 nm. Referring to FIG. 3A, in the micro-ring resonator 100 illustrated in FIG. 1, a resonance wavelength increases as the gap G between the linear waveguide 120 and the ring waveguide 130 increases.

FIG. 3B is a simulation result illustrating a change in resonance wavelength according to the effective thickness H of the waveguide in the micro-ring resonator 100 illustrated in FIG. 1. FIG. 3B shows measured resonance wavelengths when the effective thickness H of the waveguide is 366 nm, 372 nm, 380 nm, or 384 nm. Referring to FIG. 3B, in the micro-ring resonator 100 illustrated in FIG. 1, the resonance wavelength increases as the effective thickness H of the waveguide increases.

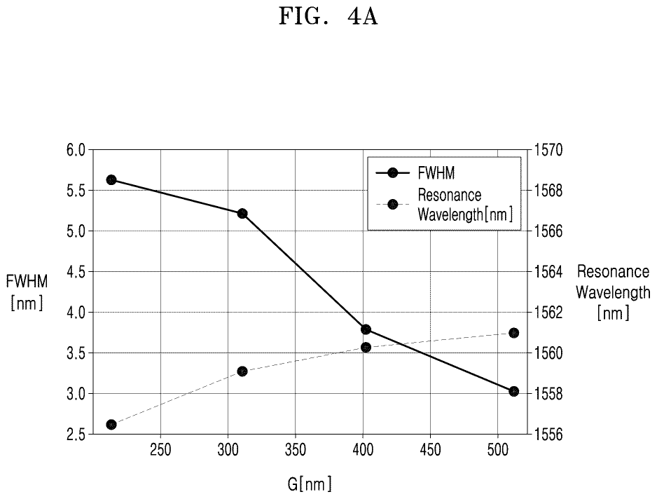

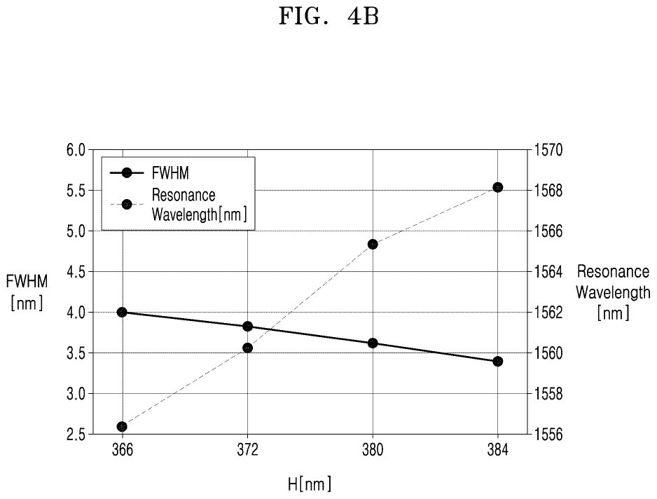

FIG. 4A is a simulation result showing a change in a full width at half maximum (FWHM) and resonance wavelength according to the gap G between the linear waveguide 120 and the ring waveguide 130 in the micro-ring resonator 100 illustrated in FIG. 1. FIG. 4A shows measured FWHMs and resonance wavelengths when the gap G between the linear waveguide 120 and the ring waveguide 130 is 217 nm, 310 nm, 403 nm, or 512 nm. Referring to FIG. 4A, in the micro-ring resonator 100 illustrated in FIG. 1, as the gap G between the linear waveguide 120 and the ring waveguide 130 increases, the FWHM decreases rapidly and the resonance wavelength slightly increases.

FIG. 4B is a simulation result showing a change in an FWHM and resonance wavelength according to the effective thickness H of the waveguide in the micro-ring resonator 100 illustrated in FIG. 1. FIG. 4B shows measured FWHMs and resonance wavelengths when the effective thickness H of the waveguide is 366 nm, 372 nm, 380 nm, or 384 nm. Referring to FIG. 4B, in the micro-ring resonator 100 illustrated in FIG. 1, as the effective thickness H of the waveguide increases, the FWHM slightly decreases and the resonance wavelength rapidly increases.

As described above, in the micro-ring resonator 100 illustrated in FIG. 1, the optical characteristics (e.g., FWHM, resonance wavelength, etc.) of the micro-ring resonator 100 change as at least one of the gap G between the linear waveguide 120 and the ring waveguide 130 and the effective thickness H of the waveguide changes. Thus, it may be difficult to secure the desired accurate optical characteristics due to deviations in optical characteristics caused by changes (FPVs) that occur during the process of manufacturing the micro-ring resonator 100. To address this problem, a method of implementing a micro-ring resonator that may secure accurate optical characteristics by controlling the optical characteristics at a stage after the micro-ring resonator is manufactured may be considered.

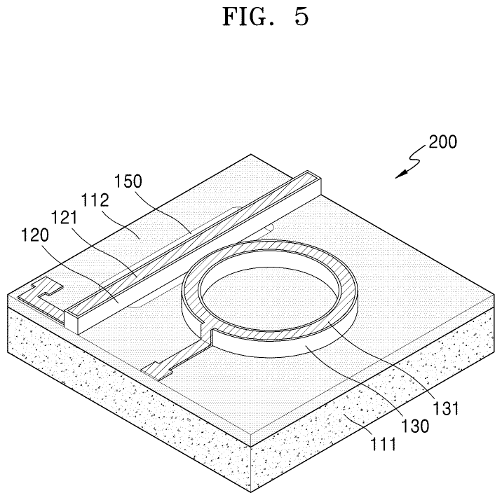

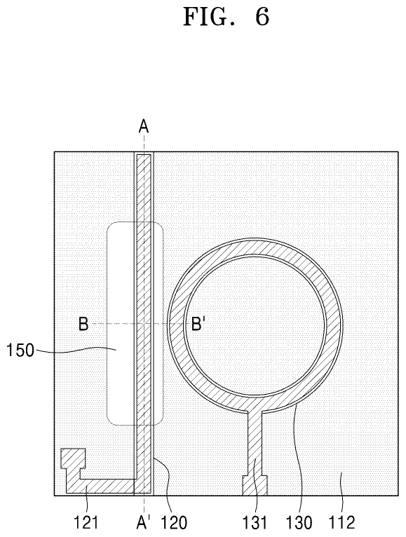

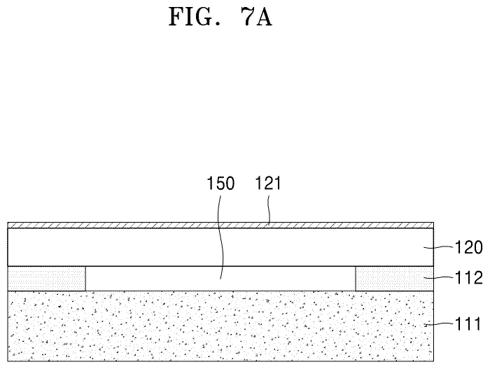

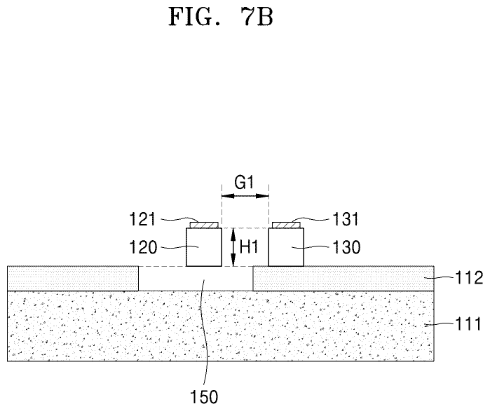

FIG. 5 is a perspective view illustrating a micro-ring resonator 200 according to an embodiment. FIG. 6 illustrates a plan view of the micro-ring resonator 200 illustrated in FIG. 5. FIG. 7A is a cross-sectional view taken along line A-A′ of FIG. 6, and FIG. 7B is a cross-sectional view taken along line B-B′ of FIG. 6.

Referring to FIGS. 5, 6, 7A and 7B, the micro-ring resonator 200 may include a substrate 111 and an insulating layer 112 formed on the substrate 111. The substrate 111 may include a conductive substrate. The substrate 111 may include, for example, silicon. However, the disclosure is not limited thereto. The insulating layer 112 may include silicon oxide. For example, the insulating layer 112 may be formed by oxidizing the surface of the substrate 111 including silicon, but is not limited thereto. As such, according to an embodiment, the insulating layer 112 may include various materials other than silicon oxide.

According the an embodiment, the micro-ring resonator 200 may include a linear waveguide 120 and a ring waveguide 130 provided on the insulating layer 112. The linear waveguide 120 may be provided on an upper surface of the insulating layer 112. The linear waveguide 120 may have a certain thickness H1. The linear waveguide 120 may include, for example, silicon. However, embodiments of the disclosure are not limited thereto. According to an embodiment, an insulating material may be provided to on the sides of the linear waveguide 120. For example, the insulating material may be provided to surround four sides of the linear waveguide 120.

According the an embodiment, a first electrode 121 may be provided on the linear waveguide 120. The first electrode 121 may include a conductive metal. For example, the first electrode 121 may include, but is not limited to, Au, Cu, Al, etc. FIG. 5 illustrates an example in which the first electrode 121 is provided on an upper surface of the linear waveguide 120. However, embodiments of the disclosure are not limited thereto, and as such, according to an embodiment, the first electrode 121 may be provided on a side surface of the linear waveguide 120 or on both the upper surface and the side surface of the linear waveguide 120.

According the an embodiment, the micro-ring resonator 200 may include a ring waveguide 130 provided on the upper surface of the insulating layer 112. The ring waveguide 130 may have the certain thickness H1. FIG. 7B illustrates an example in which the ring waveguide 130 has the same thickness H1 as the linear waveguide 120, but this is only an example. The ring waveguide 130 may include, for example, silicon. However, embodiments of the disclosure are not limited thereto. According to an embodiment, an insulating material may be provided on the sides of the ring waveguide 130. For example, the insulating material may be provided to surround four sides of the ring waveguide 130.

According the an embodiment, a second electrode 131 may be provided on the ring waveguide 130. The second electrode 131 may include a conductive metal. For example, the second electrode 131 may include, but is not limited to, Au, Cu, Al, etc. FIG. 5 illustrates an example in which the second electrode 131 is provided on an upper surface of the ring waveguide 130. However, embodiments of the disclosure are not limited thereto, and as such, according to an embodiment, the second electrode 131 may be provided on a side surface of the ring waveguide 130 or on both the upper surface and side of the ring waveguide 130.

The ring waveguide 130 may be spaced apart by a certain gap so as to be coupled with the linear waveguide 120. In an example case in which no voltage is applied between the first electrode 121 and the second electrode 131, the linear waveguide 120 and the ring waveguide 130 may be spaced apart by a first gap G1 and may be arranged to be coupled with each other. Here, the first gap G1 refers to a minimum gap between the linear waveguide 120 and the ring waveguide 130 in an example case in which no voltage is applied between the first electrode 121 and the second electrode 131.

The first effective thickness H1 of the waveguide refers to a thickness of a space where coupling is formed between the linear waveguide 120 and the ring waveguide 130 in an example case in which no voltage is applied between the substrate 111 and the first electrode 121, and refers to a thickness of a space corresponding to t portion of the linear waveguide 120 and a portion of the ring waveguide 130 that face each other. In an example case in which no voltage is applied between the substrate 111 and the first electrode 121, the first effective thickness H1 of the waveguide may be equal to the thickness H1 of each of the linear waveguide 120 and the ring waveguide 130. However, the disclosure is not limited thereto.

According the an embodiment, the micro-ring resonator 200 may include a cavity 150 formed in the insulating layer 112. The cavity 150 may be formed under the linear waveguide 120. The cavity 150 may be formed below a portion of the linear waveguide 120. For example, the portion may be adjacent to the ring waveguide 130. As described above, the portion of the linear waveguide 120, which is adjacent to the ring waveguide 130, may be arranged to hang above the cavity 150. In an example case in which a voltage is applied between the substrate 111 and the first electrode 121 and/or between the first electrode 121 and the second electrode 131 through the cavity 150, a portion of the linear waveguide 120, located above the cavity 150 may be vertically deformed toward the substrate 111 or horizontally deformed toward the ring waveguide 130.

FIGS. 7A and 7B illustrate a state in which no voltage is applied between the substrate 111, the first electrode 121, and the second electrode 131, and thus the linear waveguide is not deformed. In this case, the linear waveguide and the ring waveguide may be arranged to be spaced apart from each other by a first gap, and the first effective thickness H1 of the waveguide may be equal to the thickness H1 of each of the linear waveguide 120 and the ring waveguide 130.

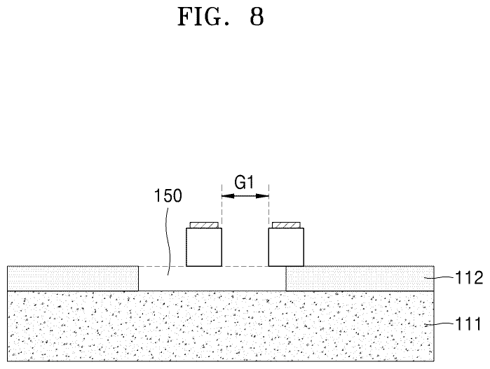

FIG. 8 illustrates a modified example of the micro-ring resonator 200 according to an embodiment, in which the cavity 150 formed in a lower surface of the portion of the linear waveguide 120, adjacent to the ring waveguide 130, may extend below a portion of the ring waveguide 130.

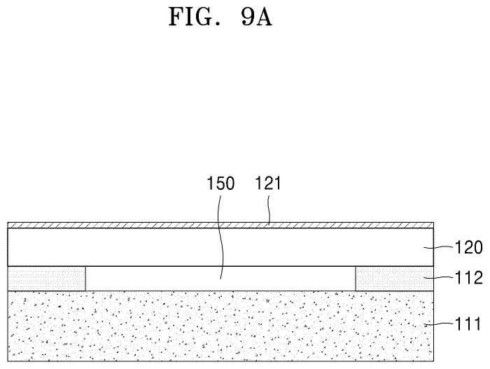

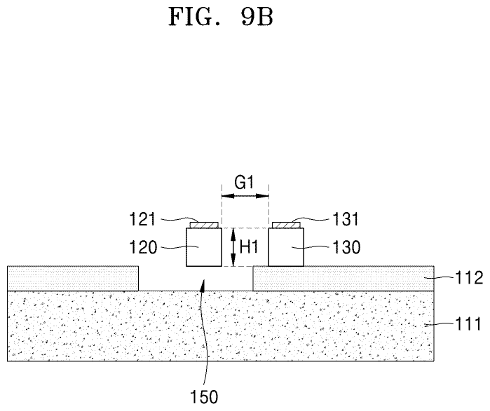

FIGS. 9A and 9B are cross-sectional views showing a state in which no voltage is applied between the substrate 111, the first electrode 121, and the second electrode 131 in the micro-ring resonator 200 according to the embodiment illustrated in FIG. 8. FIG. 9A is a cross-sectional view taken along line A-A′ of FIG. 6 in the modified example of the micro-ring resonator 200 illustrated in FIG. 8, and FIG. 9B is a cross-sectional view taken along line B-B′ of FIG. 6 in the modified example of the micro-ring resonator 200 illustrated in FIG. 8.

Referring to FIGS. 9A and 9B, in an example case in which no voltage is applied between the substrate 111, the first electrode 121, and the second electrode 131, the portion of the linear waveguide 120 adjacent to the ring waveguide 130 is not deformed. Accordingly, the linear waveguide 120 and the ring waveguide 130 may be arranged apart from each other by the first gap G1, and the first effective thickness H1 of the waveguide may be equal to the thickness H1 of each of the linear waveguide 120 and the ring waveguide 130.

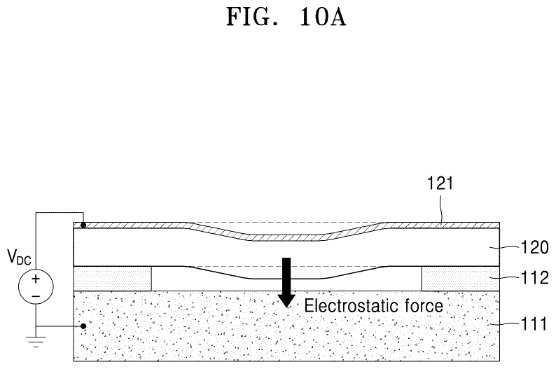

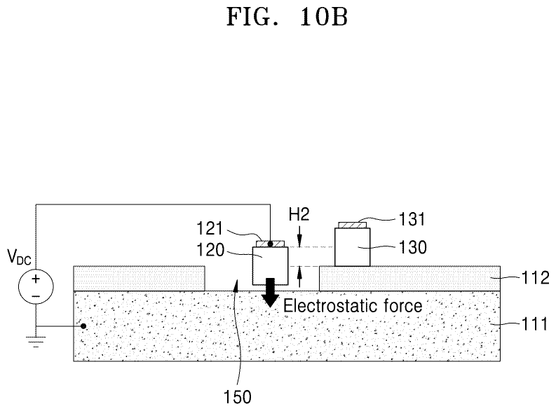

FIGS. 10A and 10B are cross-sectional views illustrating a state in which a certain voltage V_{DC} is applied between the first electrode 121 and the substrate 111 in the micro-ring resonator 200 according to the embodiment illustrated in FIG. 5. FIG. 10A is a cross-sectional view taken along line A-A′ of FIG. 6, and FIG. 10B is a cross-sectional view taken along line B-B′ of FIG. 6.

Referring to FIGS. 10A and 10B, in an example case in which the certain voltage V_{DC} is applied between the first electrode 121 and the substrate 111, an electrostatic force is applied between the portion of the linear waveguide 120 and the substrate 111, and thus the portion of the linear waveguide 120, located above the cavity 150, may be deformed. For example, the portion of the linear waveguide 120, located above the cavity 150, may be vertically deformed toward the substrate 111. Accordingly, as the portion of the linear waveguide 120, located above the cavity 150, is deformed toward the substrate 111, the effective thickness of the waveguide where the linear waveguide 120 and the ring waveguide 130 face each other may be reduced from the first effective thickness H1 to a second effective thickness H2 as shown in FIG. 10B. As described above, the effective thickness of the waveguide may be controlled by applying the certain voltage V_{DC} between the first electrode 121 and the substrate 111.

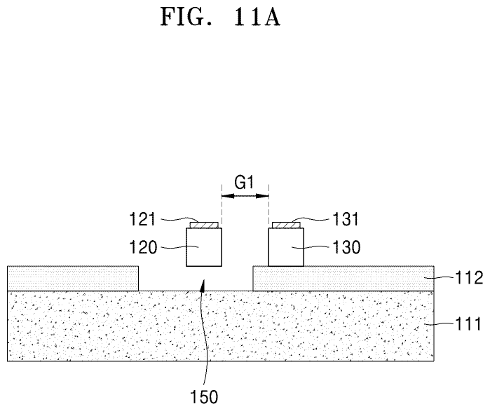

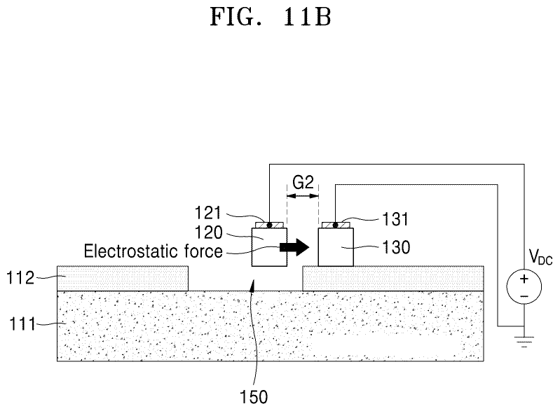

FIG. 11A is a cross-sectional view showing a state in which no voltage is applied between the substrate 111, the first electrode 121, and the second electrode 131 in the micro-ring resonator 200 according to the embodiment illustrated in FIG. 5. FIG. 11B is a cross-sectional view showing a state in which the certain voltage V_{DC} is applied between the first electrode 121 and the second electrode 131 in the micro-ring resonator 200 according to the embodiment illustrated in FIG. 5. FIGS. 11A and 11B are cross-sectional views taken along line B-B′ of FIG. 6.

Referring to FIG. 11A, in an example case in which no voltage is applied between the substrate 111, the first electrode 121, and the second electrode 131, the portion of the linear waveguide 120, located above the cavity 150, is not deformed. Thus, the linear waveguide 120 and the ring waveguide 130 may be arranged apart from each other by the first gap G1.

Referring to FIG. 11B, in an example case in which the certain voltage V_{DC} is applied between the first electrode 121 and the second electrode 131, an electrostatic force is applied between the portion of the linear waveguide 120 and the ring waveguide 130, and thus the portion of the linear waveguide 120, located above the cavity 150, may be deformed. For example, the portion of the linear waveguide 120, located above the cavity 150, may be horizontally deformed toward the ring waveguide 130. Accordingly, as the portion of the linear waveguide 120, located above the cavity 150, is deformed toward the ring waveguide 130, the linear waveguide 120 and the ring waveguide 130 may be arranged apart from each other by a second gap G2 that is smaller than the first gap G1. As described above, the gap between the linear waveguide 120 and the ring waveguide 130 may be adjusted by applying the certain voltage V_{DC} between the first electrode 121 and the second electrode 131.

In FIGS. 10A and 10B, a case is described where a voltage is applied between the substrate 111 and the first electrode 121 to vertically deform the portion of the linear waveguide 120, located above the cavity 150, toward the substrate 111, and in FIGS. 11A and 11B, a case is described where a voltage is applied between the first electrode 121 and the second electrode 131 to horizontally deform the portion of the linear waveguide 120, located above the cavity 150, toward the ring waveguide 130. By applying a voltage between the substrate 111 and the first electrode 121 and between the first electrode 121 and the second electrode 131, the portion of the linear waveguide 120, located above the cavity 150, may be both vertically and horizontally deformed.

In the micro-ring resonator 200 according to an embodiment, the first electrode 121 and the second electrode 131 are provided in the linear waveguide 120 and the ring waveguide 130, respectively, and the cavity 150 is formed under the portion of the linear waveguide 120 adjacent to the ring waveguide 130. After manufacturing the micro-ring resonator 200, by applying a voltage between the substrate 111 and the first electrode 121, the portion of the linear waveguide 120 may be vertically deformed toward the substrate 111, thereby controlling the effective thickness of the waveguide, and by applying a voltage between the first electrode 121 and the second electrode 131, the portion of the linear waveguide 120 may be horizontally deformed toward the ring waveguide 130, thereby controlling the gap between the linear waveguide 120 and the ring waveguide 130. As described above, the optical characteristics (e.g., resonance wavelength, FWHM, etc.) of the micro-ring resonator 200 may be controlled by changing the effective thickness of the waveguide and/or the gap between the linear waveguide 120 and the ring waveguide 130. Thus, after manufacturing the micro-ring resonator 200, desired optical characteristics may be accurately secured by finely adjusting the gap between the linear waveguide 120 and the ring waveguide 130 and/or the effective thickness of the waveguide.

According to the embodiment illustrated in FIG. 5, the micro-ring resonator 200 including one linear waveguide 120 and one ring waveguide 130 is described. However, embodiments of the disclosure are not limited thereto, and as such, according to another embodiment, the micro-ring resonator may include one or more linear waveguides and one or more ring resonators. For example, in a micro-ring resonator including a ring waveguide between two linear waveguides, the wavelength characteristics may be changed by adjusting the gap between the waveguides or the thickness of the waveguides, thereby changing the characteristics of an output port, and thus the micro-ring resonator may also be utilized as an optical switch.

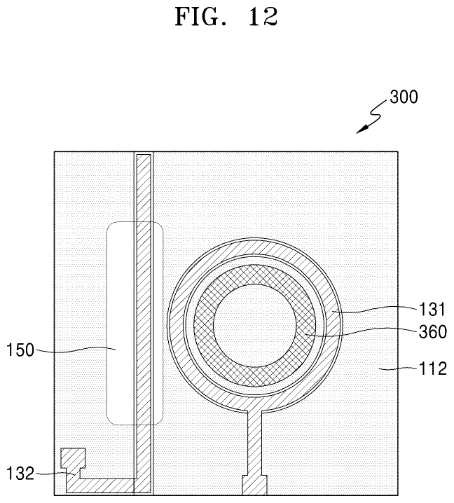

FIG. 12 is a plan view illustrating a micro-ring resonator 300 according to another embodiment. The micro-ring resonator 300 illustrated in FIG. 12 is identical to the micro-ring resonator 200 illustrated in FIG. 5, except that a modulator 360 is provided adjacent to an inner side the ring waveguide 130. The description below will focus on the differences from the micro-ring resonator 200 illustrated in FIG. 5.

Referring to FIG. 12, the modulator 360 is provided inside the ring waveguide 130. For example, the modulator 360 may be provided to surround an inner portion of the ring waveguide 130. Here, the modulator 360 is configured to modulate the optical characteristics (e.g., phase, etc.) of light passing through the ring waveguide 130. For this purpose, the modulator 360 may include a thermo-optic modulator or an electro-optic modulator. The thermo-optic modulator may modulate the phase of light passing through the ring waveguide 130 by heating the ring waveguide 130 through a heater. The electro-optic modulator may modulate the phase of light passing through the ring waveguide 130 by applying an electric field to the ring waveguide 130. Although FIG. 12 illustrates a case where the modulator 360 is provided on the inside of the ring waveguide 130, this is merely an example, and the modulator 360 may be provided on the outside of the ring waveguide 130 or may be provided on the inside and outside of the ring waveguide 130.

In the micro-ring resonator 300 illustrated in FIG. 12, the optical characteristics may be controlled by deforming the portion of the linear waveguide 120, located above the cavity 150, by applying a voltage, and the optical characteristics may also be additionally controlled through the modulator 360.

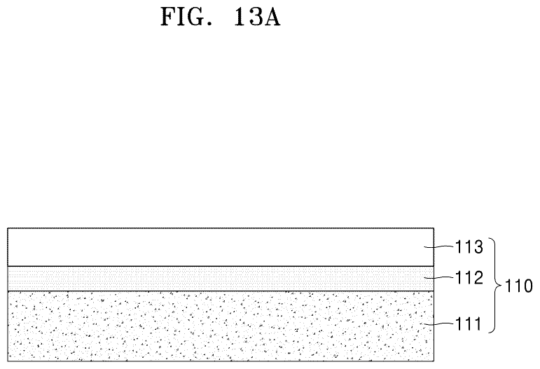

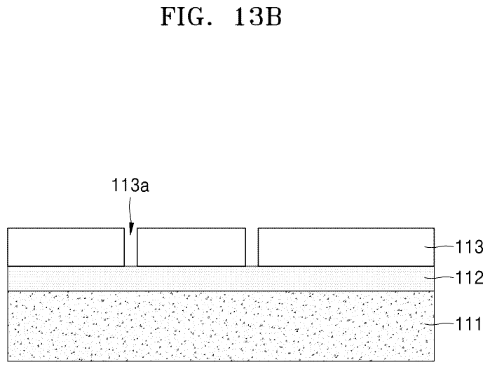

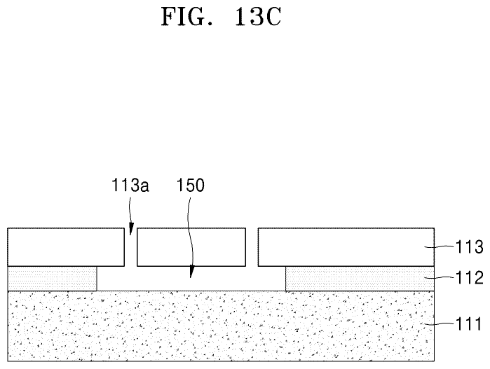

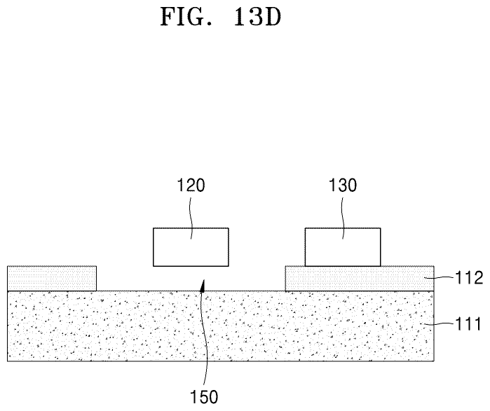

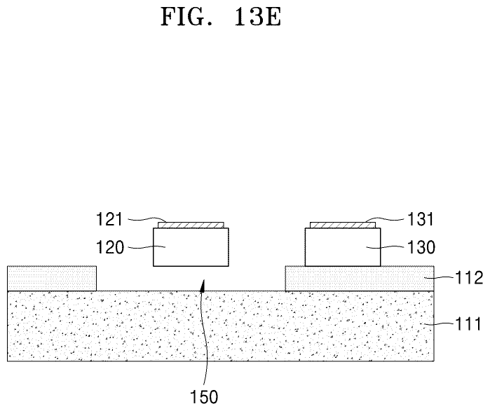

FIGS. 13A to 13E are diagrams for describing a method of manufacturing a micro-ring resonator, according to an embodiment.

Referring to FIG. 13A, the method may include preparing a silicon on insulator (SOI) wafer 110. The SOI wafer 110 includes a silicon substrate 111, an insulating layer 112, and a silicon layer 113 that are sequentially stacked. The insulating layer 112 may include, for example, silicon oxide. Referring to FIG. 13B, the method may include etching the silicon layer 113 formed on the upper surface of the insulating layer 112 to form an etch hole 113a exposing the insulating layer 112. For example, the silicon layer 113 may be etched into a certain shape to form the etch hole 113a.

Referring to FIG. 13C, the method may include forming a cavity 150 having a certain space in the insulating layer 112 by etching the insulating layer 112 through the etch hole 113a formed in the silicon layer 113. The cavity 150 may be formed, for example, by dry etching the insulating layer 112 exposed through the etch hole 113a using HF. However, embodiments of the disclosure are not limited thereto.

Referring to FIG. 13D, the method may include pattering the silicon layer 113 to form the linear waveguide 120 and the ring waveguide 130. For example, the silicon layer 113 may be patterned into a certain shape to form the linear waveguide 120 and the ring waveguide 130. Accordingly, the linear waveguide 120 and the ring waveguide 130 including silicon may be formed on the upper surface of the insulating layer 112. Here, the portion of the linear waveguide 120, adjacent to the ring waveguide 130, may be formed on the cavity 150. The linear waveguide 120 and the ring waveguide 130 may each be formed on the upper surface of the insulating layer 112 and have a certain thickness, and the linear waveguide 120 and the ring waveguide 130 may be arranged to be coupled with each other while being spaced apart from each other by a certain gap. The cavity 150 formed in the insulating layer 112 may extend to below a portion of the ring waveguide 130. According to an embodiment, after forming the linear waveguide 120 and the ring waveguide 130, an insulating material may be formed to surround each of the linear waveguide 120 and the ring waveguide 130 on four sides.

Referring to FIG. 13E, the method may include forming a first electrode 121 and a second electrode 131. For example, the first and second electrodes 121 and 131 are formed on the linear waveguide 120 and the ring waveguide 130, respectively. The first and second electrodes 121 and 131 may be formed by depositing a conductive metal on the linear waveguide 120 and the ring waveguide 130, respectively. Here, the conductive metal may include, but is not limited to, Au, Cu, Al, etc. FIG. 13E illustrates an example in which the first electrode 121 is formed on the upper surface of the linear waveguide 120, but is not limited thereto, and the first electrode 121 may be formed on the side surface of the linear waveguide 120 or may be formed on the upper surface and the side surface of the linear waveguide 120. In addition, although FIG. 13E illustrates an example in which the second electrode 131 is formed on the upper surface of the ring waveguide 130, embodiments of the disclosure are not limited thereto, and the second electrode 131 may be formed on the side surface of the ring waveguide 130 or may be formed on the upper surface and the side surface of the ring waveguide 130.

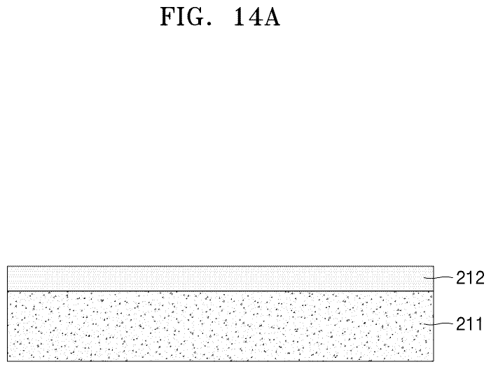

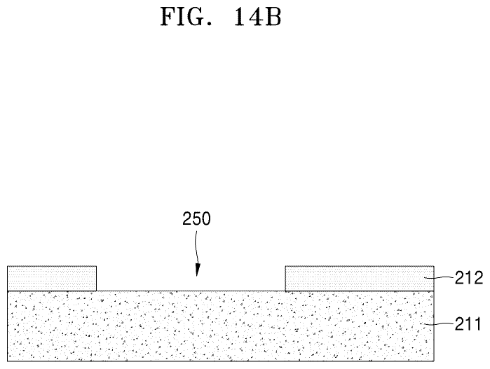

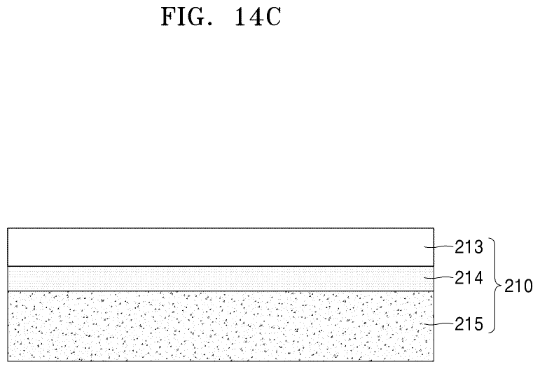

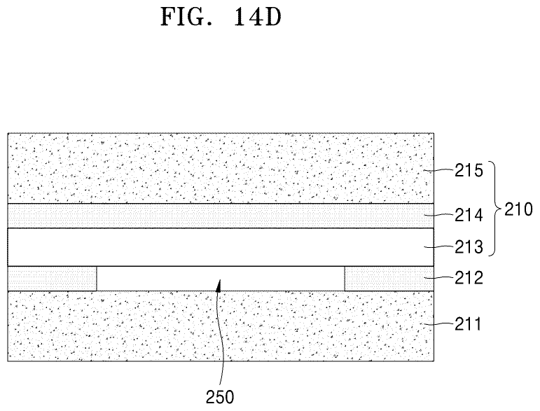

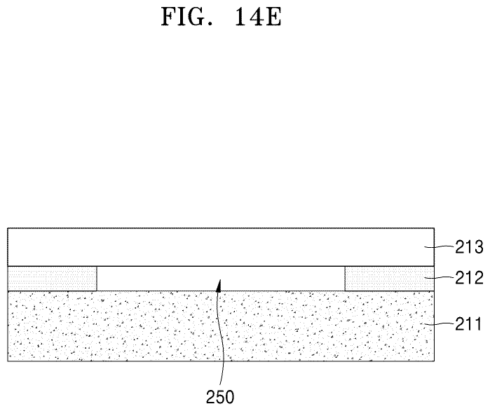

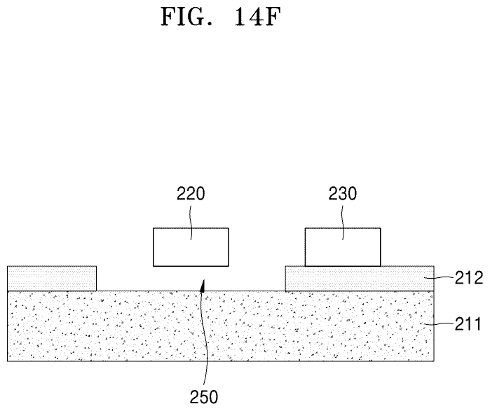

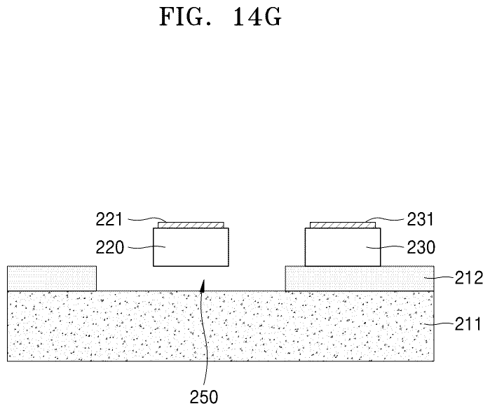

FIGS. 14A to 14G are diagrams for describing a method of manufacturing a micro-ring resonator, according to another embodiment.

Referring to FIG. 14A, the method may include preparing a first silicon substrate 211 and forming a first insulating layer 212 on an upper surface of the first silicon substrate 211. The first insulating layer 212 may include, for example, silicon oxide. The first insulating layer 212 may be formed by oxidizing the upper surface of the first silicon substrate 211. After oxidizing the upper surface of the first silicon substrate 211, a surface treatment process using oxygen plasma (O₂ plasma) may be additionally performed. The first insulating layer 212 may include various materials other than silicon oxide.

Referring to FIG. 14B, the method may include patterning the first insulating layer 212 formed on the upper surface of the first silicon substrate 211 to form a cavity 250. Referring to FIG. 14C, the method may include preparing an SOI wafer 210. The SOI wafer 210 includes a second silicon substrate 215, a second insulating layer 214, and a silicon layer 213 that are sequentially stacked.

Referring to FIG. 14D, the method may include bonding the silicon layer 213 of the SOI wafer 210 to the upper surface of a first insulating layer 212 in which the cavity 250 is formed. Here, the bonding between the first insulating layer 212 and the silicon layer 213 may be performed, for example, by silicon direct bonding (SDB). However, embodiments of the disclosure are not limited thereto.

Referring to FIG. 14E, the method may include removing the second silicon substrate 215 and the second insulating layer 214 of the SOI wafer 210. Next, referring to FIG. 14F, the method may include patterning the silicon layer 213 provided on an upper surface of the first insulating layer 212 to form the linear waveguide 220 and the ring waveguide 230. Accordingly, the linear waveguide 220 and the ring waveguide 230 including silicon may be formed on the upper surface of the first insulating layer 212. Here, a portion of the linear waveguide 220, adjacent to the ring waveguide 230, may be formed above the cavity 250. The linear waveguide 220 and the ring waveguide 230 may each be formed with a certain thickness on the upper surface of the first insulating layer 212, and the linear waveguide 220 and the ring waveguide 230 may be arranged to be coupled with each other while being spaced apart from each other by a certain interval. The cavity 250 formed in the first insulating layer 212 may extend to below a portion of the ring waveguide 230. According to an embodiment, after forming the linear waveguide 220 and the ring waveguide 230, an insulating material may be formed to surround each of the linear waveguide 220 and the ring waveguide 230 on four sides.

Referring to FIG. 14G, the method may include forming a first electrode 221 and a second electrode 231. For example, the first electrode and the second electrode are formed on the linear waveguide 220 and the ring waveguide 230. The first and second electrodes 221 and 231 may be formed by depositing a conductive metal on the linear waveguide 220 and the ring waveguide 230, respectively. Here, the conductive metal may include, but is not limited to, Au, Cu, Al, etc. In FIG. 14G, an example is illustrated, in which the first electrode 221 is formed on an upper surface of the linear waveguide 220, but embodiments of the disclosure are not limited thereto, and the first electrode 221 may be formed on a side surface of the linear waveguide 220 or may be formed on the upper surface and a side surface of the linear waveguide 220. In addition, although FIG. 14G illustrates an example in which the second electrode 231 is formed on an upper surface of the ring waveguide 230, embodiments of the disclosure are not limited thereto, and the second electrode 231 may be formed on a side surface of the ring waveguide 230 or may be formed on the upper surface and the side surface of the ring waveguide 230. Although the embodiments have been described above, they are merely examples, and various modifications therefrom may be may by those skilled in the art.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope as defined by the following claims.

What is claimed is:

1. A micro-ring resonator comprising:
a substrate;
an insulating layer on the substrate;
a linear waveguide on the insulating layer;
a first electrode on the linear waveguide;
a ring waveguide on the insulating layer and coupled with the linear waveguide; and
a second electrode on the ring waveguide,
wherein the insulating layer comprises a cavity below a portion of the linear waveguide, the portion of the linear waveguide being adjacent to the ring waveguide.

2. The micro-ring resonator of claim 1, wherein the portion of the linear waveguide is configured to vertically deform toward the substrate based on a voltage applied between the first electrode and the substrate.

3. The micro-ring resonator of claim 1, wherein the portion of the linear waveguide is configured to horizontally deform toward the ring waveguide based on a voltage applied between the first electrode and the second electrode.

4. The micro-ring resonator of claim 1, wherein the cavity extends below a portion of the ring waveguide.

5. The micro-ring resonator of claim 1, wherein the substrate comprises silicon.

6. The micro-ring resonator of claim 1, wherein each of the linear waveguide and the ring waveguide comprises a micro-ring resonator comprising silicon.

7. The micro-ring resonator of claim 1, wherein the first electrode is provided on at least one of an upper surface and a side surface of the linear waveguide, and
wherein the second electrode is on at least one of an upper surface and a side surface of the ring waveguide.

8. The micro-ring resonator of claim 7, wherein each of the first electrode and the second electrode comprises a conductive metal.

9. The micro-ring resonator of claim 1, further comprising a modulator provided adjacent to the ring waveguide.

10. The micro-ring resonator of claim 9, wherein the modulator comprises a thermo-optic modulator or an electro-optic modulator.

11. A method of manufacturing a micro-ring resonator, the method comprising:
preparing a silicon on insulator (SOI) wafer comprising a silicon substrate, an insulating layer, and a silicon layer that are sequentially stacked;
forming an etch hole in the silicon layer;
forming a cavity by etching the insulating layer through the etch hole;
forming a linear waveguide and a ring waveguide by patterning the silicon layer; and
forming a first electrode on the linear waveguide and a second electrode on the ring waveguide.

12. The method of claim 11, wherein the forming the linear waveguide comprises forming a portion of the linear waveguide above the cavity, the portion of the linear waveguide being adjacent to the ring waveguide.

13. The method of claim 12, wherein the cavity is formed to extend below a portion of the ring waveguide.

14. The method of claim 11, wherein the first electrode is formed on at least one of an upper surface of the linear waveguide and a side surface of the linear waveguide, and
wherein the second electrode is formed on at least one of an upper surface of the ring waveguide and a side surface of the ring waveguide.

15. A method of manufacturing a micro-ring resonator, the method comprising:
preparing a first silicon substrate;
forming a first insulating layer on an upper surface of the first silicon substrate;
forming a cavity by patterning the first insulating layer;
preparing a silicon on insulator (SOI) wafer comprising a second silicon substrate, a second insulating layer, and a silicon layer that are sequentially stacked;
bonding the silicon layer of the SOI wafer to the first insulating layer;
removing the second silicon substrate and the second insulating layer of the SOI wafer;
forming a linear waveguide and a ring waveguide by patterning the silicon layer; and
forming a first electrode on the linear waveguide and a second electrode on the ring waveguide.

16. The method of claim 15, wherein the forming the linear waveguide comprises forming a portion of the linear waveguide above the cavity, the portion of the linear waveguide being adjacent to the ring waveguide.

17. The method of claim 16, wherein the cavity is formed to extend below a portion of the ring waveguide.

18. The method of claim 15, wherein the first electrode is formed on at least one of an upper surface of the linear waveguide and a side surface of the linear waveguide, and
wherein the second electrode is formed on at least one of an upper surface of the ring waveguide and a side surface of the ring waveguide.

19. The method of claim 15, wherein the silicon layer of the SOI wafer is bonded to the first insulating layer by silicon direct bonding (SDB).
